(19) United States
(12) Patent Application Publication
(10) Pub. No.: US 2012/0004805 A1
(43) Pub. Date: Jan. 5, 2012

(54) TOWED VEHICLE SWAY SENSING AND NOTIFICATION DEVICE

(75) Inventors: Jon Gray, Garnett, KS (US); Paul Svoboda, Emporia, KS (US); Gary Kaminski, Emporia, KS (US)

(73) Assignee: Hopkins Manufacturing Corporation, Emporia, KS (US)

(21) Appl. No.: 12/982,192

(22) Filed: Dec. 30, 2010

Related U.S. Application Data
(60) Provisional application No. 61/296,672, filed on Jan. 20, 2010.

(51) Int. Cl. G06F 19/00

(52) U.S. Cl. 701/33.4; 701/29.1

(57) ABSTRACT

A sway sensing and notification device includes a sway sensor for sensing swaying of a towed vehicle and generating corresponding sway data; and a computing device coupled with the sway sensor for analyzing the sway data and determining when the swaying of the towed vehicle could result in an unstable driving condition. The device may also include a notification device coupled with the computing device for alerting an operator when the computing device determines that the swaying of the towed vehicle could result in an unstable driving condition.

### RELATED APPLICATIONS

This non-provisional patent application claims priority benefit with regard to all common subject matter of the earlier filed U.S. Provisional Patent Application titled “TRAILER SWAY NOTIFICATION AND RECORDING DEVICE”, Ser. No. 61/296,672, filed on Jan. 20, 2010, which is hereby incorporated by reference in its entirety into the present application.

### BACKGROUND

Trailers, boats, campers, and other towed vehicles sometimes sway when pulled behind towing vehicles. The causes of such swaying are complex and often specific to the towing and towed vehicle configurations, but to the driver of the towing vehicle, the situation is generally perceived as an unintentional and sometimes uncontrollable side-to-side movement of the towed vehicle with respect to its intended path. If the swaying becomes severe, it can disrupt the direction of both the towing and towed vehicles and can result in a total lost of control of the combined rig, often resulting in an accident.

Many attempts have been made to control such swaying. One approach has been to apply a fixed or variable force to the pivot joint between the towing and towed vehicles with friction pads, movable bars, shock absorbers, or equalizer hitches. Unfortunately, these approaches are only partially effective because they can't distinguish between a rig that is turning a corner and one that is in a sway condition. Thus, these devices can only apply a limited force to resist swaying, because a greater force would inhibit normal turning of the vehicles.

Other attempts to control swaying include the use of electric and/or anti-lock brakes on the towed vehicle and advanced stability control systems on the towing vehicle along with sophisticated control systems for applying these brakes and/or control systems in a way to reduce swaying. While these systems help reduce swaying, they are complex and can't be easily retrofitted to existing vehicles. Unfortunately, many existing towed vehicles have no brakes or are only equipped with surge brakes that are activated by the inertia of the towed vehicle pushing against the tow vehicle. Surge brakes aren't always effective, because in a sway condition it is not certain whether the towed vehicle will be pushing or pulling on the towing vehicle.

### SUMMARY

The present invention solves the above-described problems and provides a distinct advance in the art of anti-swaying devices. More particularly, the present invention provides a towed vehicle sway sensing device that helps reduce or even eliminate swaying of towed vehicles regardless of the type or even lack of brakes on the towed vehicle. The present invention accomplishes this by providing a device that attempts to distinguish between normal towed vehicle movements and potentially dangerous swaying so the latter can be reduced or eliminated before it becomes severe enough to cause an accident.

The principles of the present invention recognize that towed vehicles often experience several types of swaying. A first type of swaying is that which might be induced by a pothole, speed bump, or similar object. An impact of this nature generally causes a sideways movement in the towed vehicle compared to its normal direction of travel. The impact generally results in a sudden motion to the side, which is of moderate magnitude. A similar condition exists when the towed vehicle is subjected to a sudden gust of wind or the passing of a large truck. If the towed vehicle is otherwise stable, the forces on it immediately begin to dampen the magnitude of the sideways movement. This first type of swaying also includes minor swaying, vibrations, and other movements that are almost always experienced by towed vehicles even when they are being pulled at safe speeds and any movements of the towed vehicle attributable to normal turning and maneuvering of the towing vehicle.

A second type of swaying is where a towed vehicle experiences significant, but not yet severe, swaying that nevertheless could result in an unstable driving condition if not quickly collected. This condition is arguably the most important to a sway detection system because when a towed vehicle is almost unstable, an otherwise minor disturbance such as a pothole or gust of wind can suddenly and unexpectedly trigger more severe swaying that could otherwise be easily avoided by simply slowing down a bit. The problem is that most novice and many experienced drivers are not aware of when their towed vehicle is in this unstable zone until its too late.

A third type of swaying is sudden and severe swaying. This may occur in the case of accident avoidance, such as attempts to avoid vehicles or other objects that may suddenly block the towing vehicle's path. In these cases, a sway warning system is of little use because the vehicle operator knows that severe conditions are occurring. Providing an alarm regarding sway would not provide additional information to the operator and would likely be ignored under the circumstances anyway. A sway control system (rather than just a warning) could be of some value in this situation, but if the towed vehicle is only equipped with surge brakes, such a system is not practical.

For every towed vehicle and towing vehicle combination (rig), there is a speed threshold below which the rig is stable (mechanical conditions excepted). Swaying can therefore often be resolved by simply slowing down. The device of the present invention takes advantage of this principle by detecting when a towed vehicle is experiencing the second type of swaying described above so appropriate action can be taken before the swaying worsens to the third type of swaying.

Applicant has discovered that the second type of swaying can be detected as a low amplitude and repeating side-to-side motion of the towed vehicle. If this situation occurs for long periods of time, it means the operator is driving on the edge of stability and is at risk of sudden and uncontrolled severe sway. Most operators are not aware of this instability condition because it does not sufficiently affect the operation of the towing vehicle for them to either be aware or feel endangered. The operator assumes this to be either a safe driving condition, or at least not a risky condition.

An embodiment of the sway sensing device of the present invention comprises a sway sensor and a computing device. The sway sensor senses swaying of a towed vehicle and generates corresponding sway data. The computing device is coupled with the sway sensor and analyzes the sway data and determines when the swaying of the towed vehicle could result in an unstable driving condition. In one embodiment, the computing device looks primarily for the existence of low amplitude side-to-side motion of the towed vehicle in the 0.5 to 1.5 Hz frequency range. When this condition is observed, the computing device generates sway occurrence data that may be used for a variety of purposes as described below.

The sway occurrence data may be used, for example, to alert the driver so corrective action may be taken. Embodiments of the device may therefore further comprise a notification device coupled with the computing device for alerting an operator when the computing device determines that the swaying of the towed vehicle could result in an unstable driving condition. The notification device may be a light, a horn, a buzzer, an indicator, or a display. When the computing device determines that an unstable driving condition may occur, it triggers the notification device to provide an “unstable condition” warning. In addition, the operator may also be notified of a more traditional condition of sway with a “sway occurring” message.

Embodiments of the device may also comprise a recording device coupled with the computing device for recording the sway data and the sway occurrence data. The recording device may also record notification data indicative of each time the notification device alerts the operator. The sway data, sway occurrence data, and notification data may be associated with the date and time the corresponding swaying occurred.

The computing device may also receive speed data representative of a current speed of the towed vehicle and analyze the speed data along with the sway data to determine when the swaying could result in an unstable driving condition. The speed data may be obtained from a GPS device or a component of the towing vehicle.

The computing device may also receive towed vehicle characteristic data representative of at least one physical characteristic of the towed vehicle and use this data along with the sway data to determine when the swaying could result in an unstable driving condition. The towed vehicle characteristic data may represent a weight, a length, and/or height of the towed vehicle, or loading characteristics of the towed vehicle. The vehicle characteristic data may be sensed automatically or manually entered by an operator.

The computing device may also receive steering data representative of a steering angle of a towing vehicle and use this data along with the sway data to determine when the swaying could result in an unstable driving condition. This helps the computing device more easily distinguish between a normal vehicle turn (first type of swaying) and a swaying event that could result in vehicle instability (second type of swaying).

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is an elevational view of an exemplary towing vehicle and towed vehicle on which embodiments of the present invention may be used.

FIG. 2 is a block diagram of a sway sensing device constructed in accordance with an embodiment of the invention.

FIG. 3 is a block diagram of a sway sensing and notification device constructed in accordance with another embodiment of the invention.

FIG. 4 is a block diagram of a sway sensing and notification device constructed in accordance with yet another embodiment of the invention.

FIG. 5 is a block diagram of a sway sensing and notification device constructed in accordance with yet another embodiment of the invention.

FIG. 6 is a block diagram of a sway sensing and notification device constructed in accordance with another embodiment of the invention.

FIG. 7 is a block diagram of a sway sensing device constructed in accordance with another embodiment of the invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

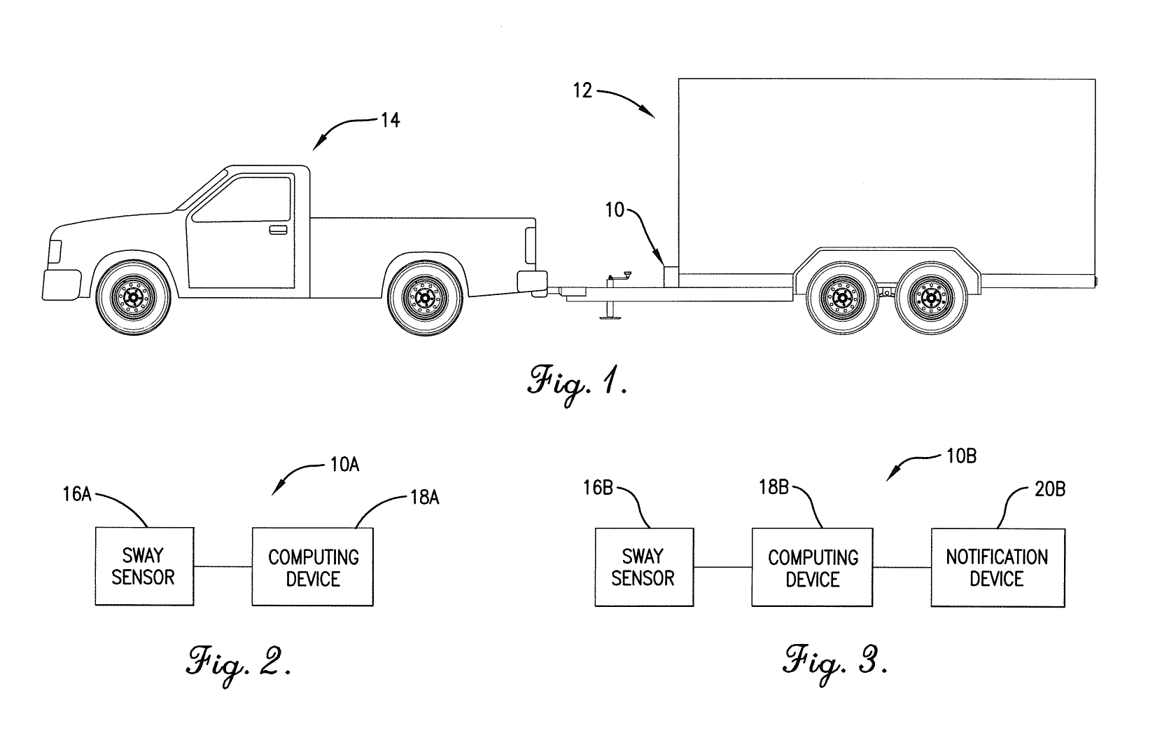

Turning now to the drawing figures, sway sensing and notification devices constructed in accordance with various different embodiments of the invention are illustrated and generally identified by the numeral 10. As depicted in FIG. 1, each device 10 is operable for sensing swaying of a towed vehicle 12 such as a trailer, boat, camper, recreational vehicle, etc. being towed behind a towing vehicle 14 such as a truck, car, van, etc. Specific embodiments of the device 10 are described below and identified in the drawing figures as 10A, 10B, 10C, 10D, 10E, and 10F.

An embodiment of a sway sensing device 10A is shown in FIG. 2 and comprises a sway sensor 16A for sensing swaying of the towed vehicle 12 and generating corresponding sway data; and a computing device 18A coupled with the sway sensor 16A for analyzing the sway data and determining when the swaying of the towed vehicle 12 could result in an unstable driving condition.

The sway sensor 16A may be any device capable of measuring or detecting swaying of the towed vehicle. In one embodiment, the sway sensor 16A is a yaw sensor that is operable to detect side-to-side movements of the towed vehicle. The yaw sensor may be mounted anywhere on the towed vehicle, but is preferably mounted toward the front of the towed vehicle. As discussed in more detail below, the sway sensor may include other types of sway sensors that may be used with, or instead of, the yaw sensor.

The computing device 18A may be a microprocessor, microcontroller, application-specific integrated circuit (ASIC), or any other device capable of implementing logical instructions. The computing device 18A may be a stand-alone device or combination of devices that only performs the functions of the present invention or may be part of a logic or control system in the towed vehicle 12 or towing vehicle 14. The computing device 18A may be hard-wired to the sway sensor 16A and positioned in a common enclosure or may be positioned remotely from the sway sensor 16A and receive data therefrom wirelessly.

Aspects of the invention may be implemented with one or more computer programs stored in or on computer-readable medium residing on or accessible by the computing device 18A. Each computer program preferably comprises an ordered listing of executable instructions for implementing logical functions in the controller. Each computer program can be embodied in any non-transitory computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can store the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

In one embodiment, the device 10A operates as follows: The sway sensor 16A continuously or at least periodically detects swaying of the towed vehicle 12 and generates corresponding sway data. The computing device 18A receives and analyzes the sway data to determine whether the swaying is likely to result in an unstable driving condition. The computing device or other circuitry may filter the data by various logical and electrical methods. The result is a stream of sway data that approximates the side-to-side movement of the towed vehicle. The computing device then analyzes this sway data to determine if the swaying could result in vehicle instability. If so, the computing device generates sway occurrence data. In one embodiment, the computing device determines if the towed vehicle is experiencing sinusoidal movement. If a potential sinusoidal motion is detected, the computing device tracks the sway data and determines both the frequency and magnitude of the motion.

In one particular embodiment, the computing device analyzes the sway data and attempts to distinguish between three categories or types of towed vehicle movement: 1) swaying or movement caused by normal and safe towing of the towed vehicle; 2) swaying or movement that is not yet severe but could quickly or easily become severe and result in an unstable driving condition; and 3) swaying that is already severe. Each of these types of swaying is discussed in more detail below.

The first type of swaying is that which might be induced by a pothole, speed bump, or similar object. An impact of this nature generally causes a sideways movement in the towed vehicle compared to its normal direction of travel. The impact generally results in a sudden motion to the side, which is of moderate magnitude. A similar condition exists when the towed vehicle is subjected to a sudden gust of wind or the passing of a large truck. If the towed vehicle is otherwise stable, the forces on it immediately begin to dampen the sideways movement. This first type of swaying also includes minor swaying, vibrations, and other movements that are almost always experienced by towed vehicles even when they are being pulled at safe speeds and any movements of the towed vehicle attributable to normal turning and maneuvering of the towing vehicle.

In one embodiment, the computing device 18A may consider any of the following towed vehicle movements to be in this first type or category of swaying:
side-to-side motion of the towed vehicle below 0.5 Hz or above 1.5 Hz in frequency that is indicative of minor swaying;
high amplitude swaying (large movements) that is infrequent and indicative of vehicle turns; or
a single or low frequency movement that quickly dampens and is indicative of a pot hole strike, gust of wind, etc.

A second type of swaying is where the towed vehicle experiences significant, but not yet severe, swaying that could easily worsen. In one embodiment, the computing device 18A may consider any of the following towed vehicle movements to be in this second type or category of swaying:
side-to-side motion of the towed vehicle below 0.5 Hz in frequency that is increasing toward the 0.5 to 1.5 Hz range;
side-to-side motion of the towed vehicle between 0.5 Hz and 1.5 Hz;
a high amplitude movement indicative of a turn, pot hole, gust of wind, etc. that does not dampen within a selected time period (e.g. 1 second, 2 seconds, or 5 seconds); or
side-to-side motion of the towed vehicle above 0.5 Hz in frequency that rapidly increases in frequency.

A third type of swaying is sudden and severe swaying. This may occur in the case of accident avoidance, such as attempts to avoid vehicles or other objects that may suddenly block the towing vehicle's path. In one embodiment, the computing device 18A may consider any of the following towed vehicle movements to be in this third type or category of swaying:
side-to-side motion of the towed vehicle in the 0.5 to 1.5 Hz frequency range that is above a threshold magnitude; or
side-to-side motion of the towed vehicle in the 0.5 to 1.5 Hz frequency range that is increasing in magnitude.

If the computing device 18A detects swaying within any of these types or categories, it generates corresponding sway occurrence data that represents or otherwise indicates that occurrence of that swaying. The sway occurrence data may be used in a variety of ways, some of which are described below.

For example, the sway occurrence data may be used to alert a vehicle operator so that corrective action may be taken. Thus, an embodiment of a towed vehicle sway sensing and notification device 10B shown in FIG. 3 is similar to the device 10A described above but also includes a notification device 20B coupled with its computing device 18B. The notification device 20B is provided for notifying or alerting an operator of the towing vehicle whenever the swaying of the towed vehicle could result in an unstable driving condition. Specifically, the computing device 18B may trigger the notification device 20B whenever it generates sway occurrence data indicative of the second type or category of swaying. This alerts the driver so the driver can slow down or take other corrective action.

In one embodiment, the notification device 20B comprises one or more lights installed on the towed vehicle 12. This keeps the entire device 10B on or in the towed vehicle 12 with no intrusion into the towing vehicle 14, thus simplifying the installation and maintenance of the device 10B. Several mounting locations for the lights are possible (the front of the driver's side fender, the front face of the towed vehicle etc). The lights could show a color or blink pattern that the operator would have to interpret. For example, a steady-state green light might indicate normal operation (swaying category 1); a blinking or stead-state yellow light might indicate a possible unstable driving condition (swaying category 2); and a blinking or steady read light night indicate severe swaying (swaying category 3).

The notification device 20B may also comprise a horn, buzzer, or similar sound emitting device. As with the lights, the sound-emitting device may be operated to distinguish between the three above-described swaying categories.

The notification device 20B may also comprise a light, beeper, or similar device in the cab of the towing vehicle 14. In this embodiment, the notification device 20B would have to be connected to the trailer-mounted portion of the device via a wired or wireless connection. The notification device in the towing vehicle could be placed in any location that is apparent to the operator such as the dash or the drivers “A” pillar. Power could be supplied by either a separate battery or the towing vehicle's electrical system. The notification device could also comprise a display screen operable to display messages such as “system powered up and functioning”, “trailer stable”, “trailer unstable”, “severe sway occurring”, etc. For operation by novice operators, it may be desirable to have more informative messages such as “trailer unstable—slow down” or “frequent trailer instability—slow down and contact rental company to resolve”.

It may also be desirable to add a sound emitting device to the notification device 20B mounted in the towing vehicle to attract the operator's attention to the message display or to provide a consistent reminder that the operator was driving in an undesirable mode. Another message could notify the operator that the sway system was not powered. This would be especially true where the remote needed to be plugged in to the cigarette lighter in order to function.

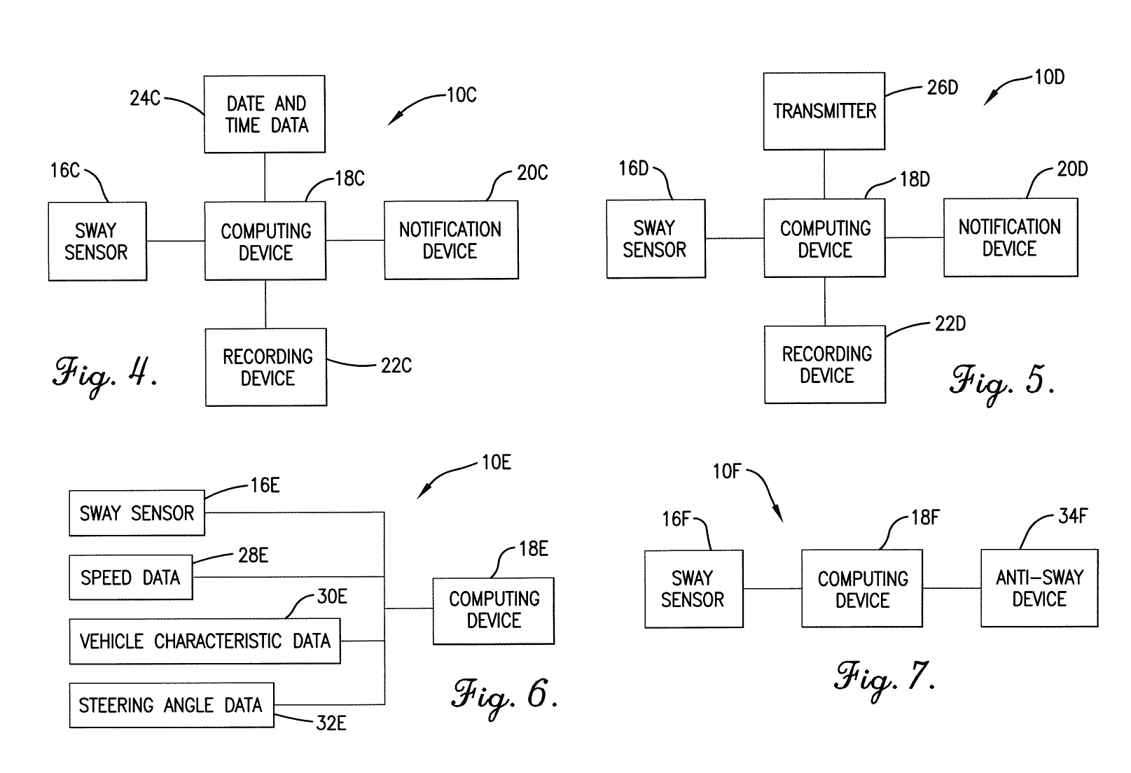

Another embodiment of a towed vehicle sway sensing and notification device 10C is shown in FIG. 4. The device 10C is similar to the device 10B described above but also includes a recording device 22C provided to record the sway data, sway occurrence data, and data representative of alerts provided by the notification device (“notification data”). The recording device 22C is provided because many operators will unfortunately ignore warnings from the notification device 20C, especially when the required action by the operator is to slow down. Because of this, it is important to know that the operator was receiving the notifications and the frequency at which the notifications were received. Obviously, the trailer stability condition immediately before any accident would be very important to a company renting or insuring the towed vehicle. A record that the operator had been repeatedly notified of an unstable condition would likewise be useful. The recording device could also assist the operator in proving that safe driving practices were being observed if the data stored indicated the towed vehicle was being pulled safely.

The recording device 22C could simply be memory associated with the computing device 18C for storing the sway data, sway occurrence data, and sway notification data. In other embodiments, the recording device 22C may comprise a video recorder, audio recorder, or other recording device. When the notification device 20C includes an electronic display, the data or information recorded could indicate what message was displayed on the notification device. The computing device and/or recording device may or be coupled with a clock and calendar 24C, so that the recording device 22C may record at what time and date a sway message or other notification was displayed or provided. The information could be retained for a period of time, possibly for a 24-hour period or a weekly period. A fixed number of recorded events could also be recorded with the newest event overwriting the oldest event once the memory is full. By knowing the date and time of all notifications, an interested party would be able to establish the identity of the driver during sway events.

The data stored by the recording device 22C could be coded for the efficiency of storage. In addition, coding would provide a more secure system by keeping the understanding of the data in a more of a “need to know” format. Naturally, the information recorded would be protected against power disconnection.

The data stored in the recording device 22C could be retrieved via any external device such as a personal computer. The recording device would allow a towed vehicle rental company to build a database on the performance of its vehicles and operator use/misuse to determine the percentage of renters that drive safely versus those that operate dangerously. With such information, it would be possible to improve the instructions/warnings given to renters. This could be advantageous in many aspect of the rental business, including any legal aspects of accidents.

Another embodiment of a towed vehicle sway sensing and notification device 10D is shown in FIG. 5. The device 10D is similar to the device 10B but also includes a transmitter 26D coupled with its computing device 18D and/or recording device 22D for transmitting the sway data, sway occurrence data, sway notification data or other information to a remote location such as a computer system operated by an owner of the towed vehicle. The transmitter 26D could be a separate cell phone transmitter or may be connected to an existing vehicle communication system (such as Onstar) via a wired or wireless connection. The transmitter 26D permits the recorder 22D to record the sway data, sway occurrence data, and sway notification, as well as notify a remote party of the data. This data could be sent directly to an interested party or though a subscription service that relayed the data to the interested party. It would also be possible to use a remote recorder at the interested party or subscription service site. This would also provide a means for direct intervention by the interested party. The interested party could be a rental company, insurance company, police, family member, etc.

The transmitted information could also include diagnostic information. For example, if the device 10D determines that the rig is moving and the notification device 20D is not functioning, the interested party could be notified. This would allow them to contact the operator for corrective action.

Another embodiment of a towed vehicle way sensing and notification device 10E is shown in FIG. 6. The device 10E is similar to the device 10A described above but also includes, or is in communication with, additional sensors and/or sources of data to assist its computing device 18E in determining whether swaying is likely to result in vehicle instability. For example, the computing device may be coupled with a source of speed data 28E that is representative of a current speed of the towed vehicle. The computing device is operable to determine when the swaying of the towed vehicle could result in an unstable driving condition based on the speed data and the sway data. In one embodiment, the computing device could place greater weight on sway data when the rig is traveling at higher speeds because swaying is more likely to worsen at high speeds. For example, at speeds below 30 mph, the computing device may only consider swaying in the 0.5 to 1.5 Hz frequency range to be in the first category of swaying, but at speeds above 30 mph, the computing device may consider this same sway frequency to be within the second category of swaying. Speed sensing could be obtained by a GPS device, connection to the towing vehicle speed sensor (directly or via a bus system), or equipping the towed vehicle with some other speed sensing device.

In another embodiment, the computing device 18E may receive towed vehicle characteristic data 30E representative of at least one physical characteristic of the towed vehicle 12 and determine when the swaying of the towed vehicle could result in an unstable driving condition based on the towed vehicle characteristic data and the sway data. The towed vehicle characteristic data may include data representative of a weight of the towed vehicle, data representative of a length of the towed vehicle, data representative of a height of the towed vehicle, or data representative of a loading balance of the towed vehicle. These characteristics could be used to establish notification zones that are more exactly tuned to a rig via an algorithm in the device.

The device 10 may also include an input device such as a keypad, USB port, or other that permits an operator to enter the vehicle characteristic data. Some of the vehicle characteristic data could also be obtained by a learn mode in the device. Such a learn mode could recognize certain events (such as turns) and measure the rig's response to these events. This would result in a profile for the rig. It may be desirable to have the device discriminate between different rig combinations or provide the operator with a manual input to designate what truck/trailer combination was being monitored.

In another embodiment, the computing device 18E may receive steering angle data 32E representative of a steering angle of the towing vehicle and determine when the swaying could result in an unstable driving condition based on the steering data and the sway data. The steering angle data assists the computing device in determining that certain towed vehicle movements are due to a turn, corner, curve, etc. rather than swaying.

Another embodiment of a towed vehicle sway sensing and notification device 10F is shown in FIG. 7. The device 10F is similar to the device 10A but also includes, or is coupled with, an anti-sway device 34F so that the device 10F can go beyond the notification of the operator and actually intervene in a sway condition. For example, the device may activate the brakes of the towed vehicle to counter sway, adjust an equalizer hitch, or alter a setting of a vehicle stability control system.

It is also possible that embodiments of the invention could be combined with other devices. One such example would be to combine aspects of the above-described devices 10-10F into a trailer brake control or a brake application system in a towed vehicle. Another would be to combine the devices into a trailer breakaway battery system.

The present invention has particular utility to the rental trailer market, but it has other applications as well. For example, certain business entities (such as lawn care services), are known to have multiple trailers operated by multiple employees. Having a sway sensing and notification device 10 on these rigs would allow an owner to determine whether any specific employee had a pattern of unsafe driving. In addition, after an accident, the data could be used to establish safe or unsafe vehicle operation. It would also help train employees in the proper loading (load distribution) of equipment on the trailer.

The devices of the present invention may also be used for training professional drivers and others. By making drivers of towing vehicles aware of unstable zones, they would be able to learn the impact of trailer load distribution and speed more quickly than without such a device.

Although the invention has been described with reference to the preferred embodiment illustrated in the attached drawing figures, it is noted that equivalents may be employed and substitutions made herein without departing from the scope of the invention as recited in the claims. For example, the device 10 or portions of this device can be mounted in different places. While the notification device 20B is preferably mounted in the operator's field of vision, it could also use an audible signal only and be mounted in a location outside the operator's field of vision. This approach could use either conventional warning noises or a voice (recording or synthesized) for operator notification. Likewise the sway sensor 16A and computing device 18A could be located anywhere on the towed vehicle 12. The preferred location of the sway sensor 16 would be dependent on the type of towed vehicle. It could also be mounted on the towing vehicle, possibly as part of the hitch or hitch accessory components (such as the equalizer hitch). Because the towed vehicle has fewer restrictions on movement than the towing vehicle, a preferred location for the sensor 16 is the towed vehicle. But via calibration, towing vehicle mounting is possible.

Having thus described the preferred embodiment of the invention, what is claimed as new and desired to be protected by Letters Patent includes the following:

1. A sway sensing device comprising:
a sway sensor for sensing swaying of a towed vehicle and generating corresponding sway data;
a computing device coupled with the sway sensor for analyzing the sway data and determining when the swaying of the towed vehicle could result in an unstable driving condition;
a notification device coupled with the computing device for alerting an operator when the computing device determines that the swaying of the towed vehicle could result in an unstable driving condition; and
a recording device coupled with the computing device for recording sway occurrence data indicative of each time the computing device determines that the swaying of the towed vehicle could result in an unstable driving condition.

2. The device as set forth in claim 1, wherein the sway sensor is a yaw sensor.

3. The device as set forth in claim 1, wherein the notification device is a light, a horn, a buzzer, an indicator, or a display.

4. The device as set forth in claim 1, the recording device being further operable for recording notification data indicative of each time the notification device alerts the operator.

5. The device as set forth in claim 4, the computing device being further operable to receive date and time data from a source thereof and to associate the sway occurrence data with a date and time the corresponding swaying occurred.

6. The device as set forth in claim 1, the computing device being further operable to receive speed data representative of a current speed of the towed vehicle and to determine when the swaying of the towed vehicle could result in an unstable driving condition based on the speed data and the sway data.

7. The device as set forth in claim 1, the computing device being further operable to receive towed vehicle characteristic data representative of at least one physical characteristic of the towed vehicle and to determine when the swaying of the towed vehicle could result in an unstable driving condition based on the towed vehicle characteristic data and the sway data.

8. The device as set forth in claim 7, wherein the towed vehicle characteristic data includes data representative of a weight of the towed vehicle, data representative of a length of the towed vehicle, data representative of a height of the towed vehicle, or data representative of a loading balance of the towed vehicle.

9. The device as set forth in claim 7, the device further comprising an input device operable to input the vehicle characteristic data for use by the computing device.

10. The device as set forth in claim 1, the computing device being further operable to receive steering data representative of a steering angle of a towing vehicle and to determine when the swaying of the towed vehicle could result in an unstable driving condition based on the steering data and the sway data.

11. The device as set forth in claim 4, the device further comprising a transmitter for transmitting the sway data, the sway occurrence data, and/or the notification data to a remote computing device.

12. A sway sensing and notification device comprising:
a sway sensor for sensing swaying of a towed vehicle and generating corresponding sway data;
a computing device coupled with the sway sensor for analyzing the sway data and determining:
a) when the swaying of the towed vehicle is not a risk to operation of the towed vehicle; or
b) when the swaying of the towed vehicle could result in an unstable driving condition;
a notification device coupled with the computing device for alerting an operator when the computing device determines that the swaying of the towed vehicle could result in an unstable driving condition; and
a recording device coupled with the computing device for recording sway occurrence data indicative of each time the computing device determines that the swaying of the towed vehicle could result in an unstable driving condition.

13. The device as set forth in claim 12, the recording device being further operable for recording notification data indicative of each time the notification device alerts the operator.

14. The device as set forth in claim 13, the computing device being further operable to receive date and time data from a source thereof and to associate the sway occurrence data and the notification data with a date and time the corresponding swaying occurred.

15. The device as set forth in claim 12, the computing device being further operable to receive speed data representative of a current speed of the towed vehicle and to determine when the swaying of the towed vehicle could result in an unstable driving condition based on the speed data and the sway data.

16. The device as set forth in claim 12, the computing device being further operable to receive towed vehicle characteristic data representative of at least one physical characteristic of the towed vehicle and to determine when the swaying of the towed vehicle could result in an unstable driving condition based on the towed vehicle characteristic data and the sway data.

17. The device as set forth in claim 12, the device further comprising a transmitter for transmitting the sway data or the sway occurrence data to a remote computing device.

18. The device as set forth in claim 12, the computing device being further operable to determine when the swaying of the towed vehicle is severe and has already resulted in an unstable driving condition.

19. A sway sensing and notification device comprising:
a sway sensor for sensing swaying of a towed vehicle and generating corresponding sway data;
a computing device coupled with the sway sensor for analyzing the sway data and determining:
a) when the swaying of the towed vehicle is not a risk to operation of the towed vehicle;
b) when the swaying of the towed vehicle could result in an unstable driving condition; or
c) when the swaying has already resulted in an unstable driving condition; and
a notification device coupled with the computing device for alerting an operator when the computing device determines that the swaying of the towed vehicle could result in an unstable driving condition.

20. The device as set forth in claim 19, further comprising a recording device coupled with the computing device for recording sway occurrence data indicative of each time the computing device determines that the swaying of the towed vehicle could result in an unstable condition.

21. The device as set forth in claim 20, the recording device being further operable for recording notification data indicative of each time the notification device alerts the operator.

22. The device as set forth in claim 21, the device further comprising a transmitter for transmitting the sway data, the sway occurrence data, or the notification data to a remote computing device.
